(19) United States
(12) Patent Application Publication
(10) Pub. No.: US 2013/0242782 A1
(43) Pub. Date: Sep. 19, 2013

(54) Method and Apparatus for Adjusting Transmission Power in a Radio System

(71) Applicants: Agnieszka Szufarska, Gdansk (PL); Klaus Ingemann Pedersen, Aalborg (DK)

(72) Inventors: Agnieszka Szufarska, Gdansk (PL); Klaus Ingemann Pedersen, Aalborg (DK)

(73) Assignee: Nokia Siemens Networks Oy, Espoo (FI)

(21) Appl. No.: 13/809,180

(22) PCT Filed: Jul. 9, 2010
(86) PCT No.: PCT/EP2010/059906

§ 371 Date: May 28, 2013

(51) Int. Cl. H04W 24/02

(52) U.S. Cl. CPC H04W 24/02
USPC 370/252

(57) ABSTRACT

The invention relates to a method and apparatus to adjust transmission of a closed subscriber group node for improving radio coverage when the signal power received from the strongest co-channel open-access cell e.g. macro cell and the handover rate in the node does not fulfil set conditions.

### FIELD

The invention relates to apparatuses, a method, system, computer program, computer program product and computer-readable medium.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

A communication network may comprise both “open” cells and “private” cells accessible only for a closed subscriber group. The service of such a group is restricted only for members and not for the use of the general public. However, users outside the group may be allowed as guests members.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: receive conditions set for signal power received from a strongest co-channel open-access cell and for a handover rate in a node; monitor signal power received from the strongest co-channel open-access cell and a handover rate in the node; and adjust transmission power of the node for improving radio coverage in the case the signal power received from the strongest co-channel open-access cell and/or the handover rate in the node does not fulfill the set conditions.

According to another aspect of the present invention, there is provided a method comprising: receiving conditions set for signal power received from a strongest co-channel open-access cell and for a handover rate in a node; monitoring signal power received from the strongest co-channel open-access cell and a handover rate in the node; and if the signal power received from the strongest co-channel open-access cell and/or the handover rate in the node does not fulfill the set conditions, adjusting transmission power of the node for improving radio coverage.

According to yet another aspect of the present invention, there is provided an apparatus comprising: means for receiving conditions set for signal power received from a strongest co-channel open-access cell and for a handover rate in a node; means for monitoring signal power received from the strongest co-channel open-access cell and a handover rate in the node; and if the signal power received from the strongest co-channel open-access cell and/or the handover rate in the node does not fulfill the set conditions, means for adjusting transmission power of the node for improving radio coverage.

According to yet another aspect of the present invention, there is provided a computer program product embodied on a computer readable medium, the computer program being configured to control a processor to perform: receiving conditions set for signal power received from a strongest co-channel open-access cell and for a handover rate in a node; monitoring signal power received from the strongest co-channel open-access cell and a handover rate in the node; and if the signal power received from the strongest co-channel open-access cell and/or the handover rate in the node does not fulfill the set conditions, adjusting transmission power of the node for improving radio coverage.

According to yet another aspect of the present invention, there is provided a computer-readable medium encoded with instructions that, when executed by a computer, perform: receiving conditions set for signal power received from a strongest co-channel open-access cell and for a handover rate in a node; monitoring signal power received from the strongest co-channel open-access cell and a handover rate in the node; and if the signal power received from the strongest co-channel open-access cell and/or the handover rate in the node does not fulfill the set conditions, adjusting transmission power of the node for improving radio coverage.

### LIST OF DRAWINGS

Some embodiments of the present invention are described below, by way of example only, with reference to the accompanying drawings, in which

FIG. 1 illustrates an example of a system;

FIG. 2 is a flow chart;

FIG. 3 illustrates examples of an apparatus.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on LTE Advanced, LTE-A, that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. For example, the embodiments are applicable to both frequency division duplex (FDD) and time division duplex (TDD).

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the (e)NodeB.

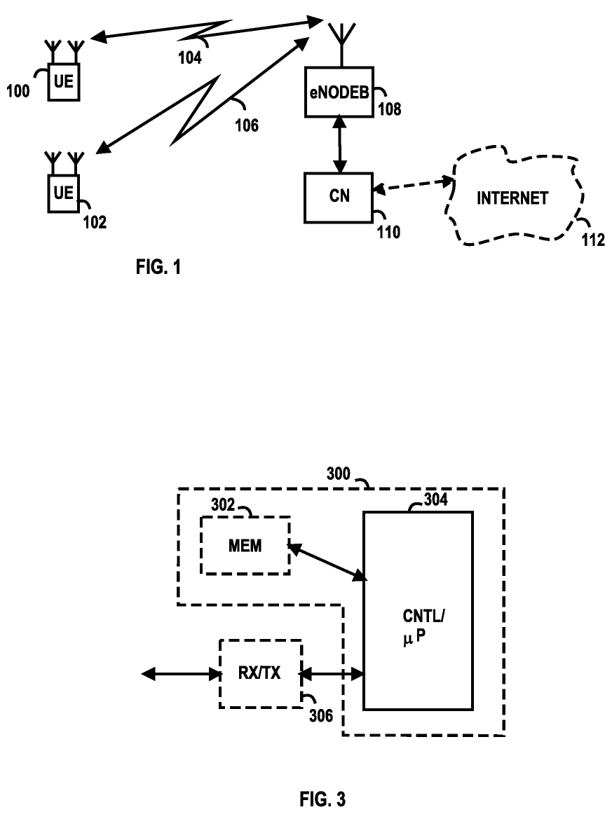

FIG. 1 is an example of a simplified system architecture only showing some elements and functional entities, all being logical units whose implementation may differ from what is shown. The connections shown in FIG. 1 are logical connections; the actual physical connections may be different. It is apparent to a person skilled in the art that the system typically comprises also other functions and structures than those shown in FIG. 1. The embodiments are not, however, restricted to the system given as an example but a person skilled in the art may apply the solution to other communication systems provided with the necessary properties.

FIG. 1 shows a part of a radio access network of E-UTRA, LTE or LTE-Advanced (LTE-A). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to a base station, an access point or any other type of interfacing device including a relay station capable of operating in a wireless environment.

The (e)NodeB includes transceivers, for instance. From the transceivers of the (e)NodeB, a connection is provided to an antenna unit that establishes bidirectional radio links to the user devices. The antenna unit may comprise a plurality of antennas or antenna elements. The (e)NodeB is further connected to a core network 110 (CN). Depending on the system, the counterpart on the CN side can be a serving system architecture evolution (SAE) gateway (routing and forwarding user data packets), packet data network gateway (PDN GW), for providing connectivity to user devices (UEs) to external packet data networks, or mobile management entity (MME), etc.

A communications system typically comprises more than one (e)NodeB in which case the (e)NodeBs may also be configured to communicate with one another over links, typically radio links, designed for the purpose. These links may be used for signalling purposes. The communication system is also able to communicate with other networks, such as a public switched telephone network or the Internet 112.

The user device (also called UE, user equipment, user terminal, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, laptop computer, game console, notebook, and multimedia device. The user device (or in some embodiments a layer 3 relay node) is configured to perform one or more of user equipment functionalities described below with an embodiment, and it may be configured to perform functionalities from different embodiments. The user device may also be called a subscriber unit, mobile station, remote terminal, access terminal, user terminal or user equipment (UE) just to mention but a few names or apparatuses.

It should be understood that, in the FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented. It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. The concept of Home(e)nodeB is explained in further detail below. Typically, in a geographical area of a radio communication system there is provided a plurality of different kinds of radio cells as well as a plurality of radio cells as also shown in FIG. 1. Radio cells may be macro cells (or umbrella cells) which are large cells, usually having a diameter of up to tens of kilometres, or smaller cells such as micro-, femto- or picocells. A cellular radio system may be implemented as a multilayer network including several kinds of cells, such as macro-, micro-, femto- and picocells. The (e)NodeB 108 of FIG. 1 may provide any kind of these cells. Typically, in multilayer networks, one node B provides one kind of a cell or cells, and thus a plurality of node Bs are required to provide such a network structure.

The network supporting the concept of Home (e)NodeBs (H(e)NodeB), typically includes a home node B gateway, or HNB-GW. A HNB Gateway (HNB-GW), which is typically installed within an operator's network aggregates traffic from a large number of HNBs back to a core network through Iu-cs and Iu-ps interfaces.

A home (e)NodeB (sometimes being comparable to a femto or pico node) when coupled to broadband services providing an umbrella cell provides radio coverage to user devices. H(e)NBs may provide the capabilities of a standard node B or a base station as well as the radio resource management functions of a standard radio network controller (RNC). It may be a relay node as well.

A H(e)NB may be a wireless access point purchased, installed and operated by a private user, a single user or a community, such as a university or a shopping centre. Then the H(e)NB may provide a closed subscription group (CSG) cell. The concept of CSG has been started in 3rd generation partnership project (3GPP) in release 8 and has been further developed since. A private network is only available for user devices (also called user equipment, UE, user terminal, etc.) that are allowed or authorized to access that is registered subscribers or guests.

A plurality of home (e) nodeBs may be linked together. Thus CSG networks may comprise one or more cells. A CSG member is a user registered to a CSG network typically by a CSG administrator. Typically, group members prioritize the CSG network over other available cells. CSG networks may be used to provide improved, for example higher data rate, services or free or low cost services to users.

A home NodeB may be used in a local area network (LAN) which is a computer network covering a relatively small geographical area, such as a home or office. Similar kinds of networks are personal area networks (PANs), campus area networks (CANs), or metropolitan area networks (MANS). Another network system where H(e)NBs are typically used is a Wide Area Network (WAN) which is a network covering a relatively broad area. A WAN may be defined to be a network whose coverage crosses metropolitan, regional, or national boundaries. Probably the best-known example is the Internet.

An example of a network system is also a mixed Local Area/Wide Area (LA/WA) scenario in which several cellular networks of the same radio access technology (e.g. E-UTRA) being operated by different operators are deployed in the same geographical area, such as a modern home-and-office building complex, and are using the same radio spectrum resources.

The mixed LA/WA scenarios may for instance refer to hierarchical cell structures, such as to a LTE/LTE or LTE/LTE-A co-existence or hot spots with overlay network. Within LA/WA coverage, H(e)NBs or local node Bs (LNBs) of the same or different networks may be placed and set up next to each other in a short distance in a spatially uncoordinated fashion.

It should be appreciated that embodiments may also be applied to other networks than to LTE or LTE-Advanced. As an example of such networks are herein taken High Speed Packet Access (HSPA) networks. High Speed Packet Access is designed to be able to provide high data rate transmission to support multimedia services. HSPA allows networks based on Universal Mobile Telecommunications System (UMTS) to have higher data transfer rates and capacity. HSPA includes High Speed Downlink Packet Access (HSDPA) and/or High Speed Uplink Packet Access (HSUPA). HSUPA uses a packet scheduler and it operates on a request-grant principle that is a user device requests a permission to send data and the packet scheduler decides on resource allocation. Further rate increases are available with evolved HSPA, also called HSPA+. Additionally, evolved HSPA introduces optional all-Internet Protocol (IP) architecture in the case node Bs or base stations are directly coupled to an IP based backhaul.

In the following, an embodiment of a method for downlink power control is explained in further detail. The embodiment is especially suitable for heterogeneous networks comprising a mixture of open-access cells, such as macro cells, and CSG H(e)NBs. Open-access cells means “normal” radio cells to which for example subscribers of the radio cell operator and accepted roamers have access to. In these networks, interference management may be quite a challenging task, especially if the open-access cell coverage is to be provided in the range of the CSG cells including open-access cell user UEs close to a CSG H(e)NB to which they are not allowed to have an access. In these heterogeneous systems, typically, the primary goal is to guarantee services of good quality to open-access cell users. A simple method of protecting open-access users from excessive CSG interference is that a H(e)NB located close to open-access cell centre is allowed to transmit by using a higher maximum power, since it is quite improbable that these CSG users cause a coverage hole for open-access cell users. Whereas a H(e)NB located at a cell-edge is allowed to transmit by using a lower maximum power. The power control scheme is disclosed in further detail in 3GPP Tdoc R4-094245. This power control scheme is based on an equation which has two parameters:

affecting to the slope of power control curve and

affecting to a pathloss correction offset. Different settings of these parameters enable optimization of the downlink power of a H(e)NB and a trade-off between open-access and CSG cell user performance.

However, prioritizing of open-access cell users may lead to a situation where some users are not able to connect to a H(e)NB located at a cell-edge due to reduced radio coverage of this node. Thus an enhancement to the conventional power control scheme of H(e)NB downlink is needed in this regard.

An embodiment starts in block 200.

In block 202, conditions set for signal power received from a strongest co-channel open-access cell and for a handover rate in a node are received. The open-access cell is typically a macro cell, but it can be of any type, such as a pico cell or a relay node cell.

In an embodiment, the node is a H(e)NB.

The conditions may be based on setting a threshold for both parameters. A person skilled in the art may determine these thresholds based on his experience, simulations and/or theoretical analysis, etc.

The threshold for signal power received from a cell may be set for received signal reference power (RSRP). RSRP measurements belong to physical layer measurements in LTE or LTE-advanced. A user device or a node may measure RSRP to obtain information on the strength of cells. It is used in calculating path loss which in turn is used in power setting algorithms for determining optimal transmission powers in a network.

A handover rate is a critical parameter for network operation, since they require a lot of processing capacity and they require time. Further, every now and then a handover does not succeed, and a call is dropped or a data connection is cut off. If a user device has to carry out continuous handovers due to a poor radio field, best measure a network can usually take is to increase transmission power. Thus, a handover rate is a good indicator for an adequate transmission power.

The thresholds are typically set automatically by network control functions, such as operation and maintenance functions or by the operator of the network in a configuration phase. The thresholds may also be updated if required. The condition for the signal power received from the strongest co-channel open-access cell may be that it must be at least at the level of the threshold and the condition for the handover rate may be that it must not reach the set threshold.

In block 204, the signal power received from the strongest co-channel open-access cell and the handover rate in the node is monitored. The signal power may be monitored by carrying out measurements or receiving measurement results and the handover rate by keeping track on handovers. if the signal power received from the strongest co-channel open-access cell and/or the handover rate in the node do/does not fulfill the set conditions, the transmission power of the node is adjusted for improving radio coverage (block 206).

The condition for the signal power received from the strongest co-channel open-access cell may be that it must be at least at the level of the threshold. If the condition is not fulfilled, the node is subjected to power control optimization. Other options naturally exist.

The condition for the handover rate may be that it must not reach the set threshold. If the handover rate is too high (condition is not met), the node is subjected to power control optimization. Other options naturally exist. It should be appreciated that both the conditions may be monitored, but power control optimization may be triggered by not fulfilling either or both of them.

In the following, some of the options are further clarified.

First, if both conditions are not fulfilled: the adjustment of the transmission power of the node acting as a handover source node or target node comprises at least one of: usage of a maximum power, adjustment of power control parameters controlling slope of power control curve and/or pathloss correction offset, and usage of a maximum power on a dedicated frequency only. The dedicated frequency may be authorized for more effective CSG operation in one or more CSG cells by an operator or administrator or by the overlay macro cell. The adjusted parameters may be preconfigured in a configuration phase or signaled from the network.

Second, if the handover rate in the node does not fulfill the set condition the adjustment of the transmission power of the node acting as a handover source node or target node comprises usage of a maximum transmission power on a dedicated frequency. The dedicated frequency may be authorized for more effective CSG operation in one or more CSG cells by an operator or administrator or by the overlay macro cell.

Third, if the signal power received from the strongest co-channel open-access cell does not fulfill the set condition, the adjustment of the transmission power of the node acting as a handover source node comprises at least one of: usage of a maximum power, adjustment of power control parameters controlling slope of power control curve and/or pathloss correction offset, and usage of a maximum power on a dedicated frequency only. The dedicated frequency may be authorized for more effective CSG operation in one or more CSG cells by an operator or administrator or by the overlay macro cell. The adjusted parameters may be preconfigured in a configuration phase or signaled from the network.

It should be understood that in this case no coverage problems take place at a target handover node.

The adjustment of the transmission power of a node may be carried out based on equation:

Pₜₓ=max(min(α*PM+β,Pₘₐₓ),Pₘᵢₙ), (1)

wherein

max denotes a maximum,

min denotes minimum,
α denotes a parameter affecting to the slope of power control curve,
* denotes multiplication,
   PM denotes measured co-channel power from a selected macro node (e.g. the strongest one),
   β denotes a parameter affecting to a pathloss correction offset,
   Pₘₐₓ denotes maximum power, and
   Pₘᵢₙ denotes minimum power.

Equation (1) gives power adjustment in dBs.

It should be appreciated that it is possible a node may not being able to increase its transmission power if not authorized by network control, such as operation and maintenance functions.

Typically, in each case the selection of actions from the optional choices may be based on the instructions of operation and maintenance functions and/or an operator may make a preferable order of actions based on optimizing network's operation.

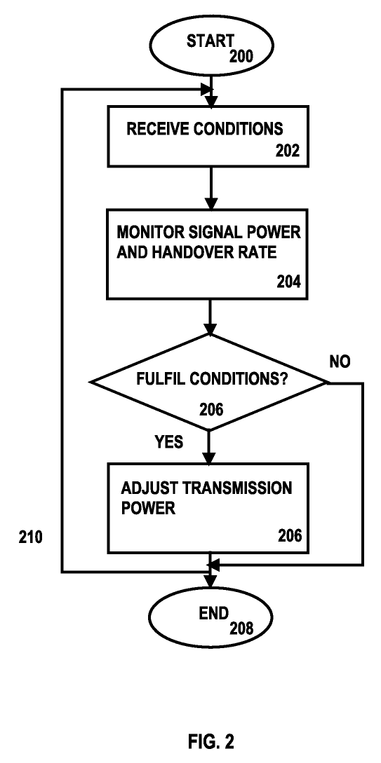

The embodiment ends in block 208. The embodiment is repeatable in many ways. One example is shown by arrow 210 in FIG. 2.

The steps/points, signaling messages and related functions described above in FIG. 2 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point.

It should be understood that transmitting and/or receiving may herein mean preparing a transmission and/or reception, preparing a message to be transmitted and/or received, or physical transmission and/or reception itself, etc on a case by case basis.

In the following, an example of a communication system, wherein the embodiment of FIG. 2 may be applied to, is explained in more detail. The system is based on the part of a communication system described in FIG. 1. An example of a network wherein embodiments can be applied to are heterogeneous networks with one or more open-access cells and H(e)NodeB cells which may be targeted to a restricted group of users. One example of such a H(e)NodeB cell which restricted access is a closed subscriber group (CSG) cell. In this exemplifying case, the system is served by an “umbrella” cell (macro cell) provided by an (e)NodeB which is not shown in the FIG. 1. In the system, a plurality of different kinds of nodes are provided, at least part of them being H(e)NodeBs (or “plug-and-play” (e)NodeBs). Each H(e)NodeBs may provide a lower level node. H(e)NodeB may be a any node, server or host provided by necessary functionalities, it may even be a developed user device, such as a laptop, multimedia device or some other computer device furnished with a network stick or a corresponding device. A developed network stick may also provide all the necessary functionalities. In the example of FIG. 1, (e)NodeB is a H(e)NodeB providing a femto or pico cell. Embodiments may also be applied to other networks, as already stated above. As an example of such networks are herein taken High Speed Packet Access (HSPA) networks. High Speed Packet Access is designed to be able to provide high data rate transmission to support multimedia services. HSPA allows networks based on Universal Mobile Telecommunications System (UMTS) to have higher data transfer rates and capacity. HSPA includes High Speed Downlink Packet Access (HSDPA) and/or High Speed Uplink Packet Access (HSUPA). HSUPA uses a packet scheduler and it operates on a request-grant principle that is a user device requests a permission to send data and the packet scheduler decides on resource allocation. Further rate increases are available with evolved HSPA, also called HSPA+. Additionally, evolved HSPA introduces optional all-Internet Protocol (IP) architecture in the case nodeBs or base stations are directly coupled to an IP based backhaul.

An embodiment provides an apparatus which may be any node, host, user device, network stick or any other suitable apparatus able to carry out processes described above in relation to FIG. 2.

FIG. 3 illustrates a simplified block diagram of an apparatus according to an embodiment especially suitable for component carrier selection and/or reselection. It should be appreciated that the apparatus may also include other units or parts than those depicted in FIG. 3. Although the apparatus has been depicted as one entity, different modules and memory may be implemented in one or more physical or logical entities.

The apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as singlechip computer element, or as a chipset, including at least a memory for providing storage capacity used for arithmetic operation and an operation processor for executing the arithmetic operation.

As an example of an apparatus according to an embodiment, it is shown an apparatus, such as a node device, including facilities in a control unit 300 (including one or more processors, for example) to carry out functions of embodiments, such as negotiations between node devices for obtaining resources. This is depicted in FIG. 3.

Another example of an apparatus may include at least one processor 304 and at least one memory 302 including a computer program code, the at least one memory and the computer program code configured to, with the at least one processor, cause the apparatus at least to: receive conditions set for signal power received from a strongest co-channel open-access cell and for a handover rate in a node, monitor the signal power received from the strongest co-channel open-access cell and the handover rate in the node, and adjust transmission power of the node for improving radio coverage in the case the signal power received from the strongest co-channel open-access cell and/or the handover rate in the node does not fulfill the set conditions.

Yet another example of an apparatus comprises means 304 for receiving conditions set for signal power received from a strongest co-channel open-access cell and for a handover rate in a node, means 304 for monitoring the signal power received from the strongest co-channel open-access cell and the handover rate in the node, and means 304 for adjusting transmission power of the node for improving radio coverage in the case the signal power received from the strongest co-channel open-access cell and/or the handover rate in the node does not fulfil the set conditions.

Yet another example of an apparatus comprises a receiving unit 304 (or 306 in combination with 304 for the purpose of signal processing) configured to receive conditions set for signal power received from a strongest co-channel open-access cell and for a handover rate in a node, a monitoring unit 304 configured to monitor the signal power received from the strongest co-channel open-access cell and the handover rate in the node, and an adjuster 304 configured to adjust transmission power of the node for improving radio coverage in the case the signal power received from the strongest co-channel open-access cell and/or the handover rate in the node does not fulfil the set conditions.

It should be appreciated that different units may be implemented as one module, unit, processor, etc, or as a combination of several modules, units, processor, etc.

It should be understood that the apparatuses may include other units or modules etc. used in or for transmission. However, they are irrelevant to the embodiments and therefore they need not to be discussed in more detail herein. Transmitting may herein mean transmitting via antennas to a radio path, carrying out preparations for physical transmissions or transmission control, etc. depending on the implementation. Receiving may herein mean receiving via antennas from a radio path, carrying out preparations for physical receptions or reception control, etc. depending on the implementation. The apparatus may utilize a transmitter and/or receiver which are not included in the apparatus itself, such as a processor, but are available to it, being operably coupled to the apparatus. This is depicted in FIG. 3 as transceiver 306.

An embodiment provides a computer program embodied on a distribution medium, comprising program instructions which, when loaded into an electronic apparatus, constitute the apparatus as explained above.

Another embodiment provides a computer program embodied on a computer readable medium, configured to control a processor to perform embodiments of the method described above.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
receive conditions set for signal power received from a strongest co-channel open-access cell and for a handover rate in a node;
monitor signal power received from the strongest co-channel open-access cell and a handover rate in the node; and adjust transmission power of the node for improving radio coverage in the case the signal power received from the strongest co-channel open-access cell and/or the hand-over rate in the node does not fulfill the set conditions.

2. The apparatus of claim 1, wherein the node is a closed subscriber group node.

3. The apparatus of claim 1, wherein the adjustment of the transmission power of the node acting as a handover source node or target node comprises at least one of: usage of a maximum power, adjustment of power control parameters controlling slope of power control curve and/or pathloss correction offset, and usage of a maximum power on a dedicated frequency only, in the case the signal power received from the strongest co-channel open-access cell and the handover rate in the node do not fulfil the set conditions.

4. The apparatus of claim 1, wherein the adjustment of the transmission power of the node acting as a handover source node or target node comprises usage of a maximum transmission power on a dedicated frequency in the case the handover rate in the node does not fulfil the set condition.

5. The apparatus of claim 1, wherein the adjustment of the transmission power of the node acting as a handover source node comprises at least one of: usage of a maximum power, adjustment of power control parameters controlling slope of power control curve and/or pathloss correction offset, and usage of a maximum power on a dedicated frequency only, if the signal power received from the strongest co-channel open-access cell does not fulfil the set condition.

6. The apparatus of claim 1, wherein the signal power received from a strongest co-channel open-access cell is a received signal reference power.

7. The apparatus of claim 1, wherein in each case the selection of actions to be taken is based on the instructions of operation and maintenance functions.

8. The apparatus of claim 1, the apparatus comprising a node.

9. A computer program comprising program instructions which, when loaded into the apparatus, constitute the modules of claim 1.

10. A method comprising:
receiving conditions set for signal power received from a strongest co-channel open-access cell and for a handover rate in a node;
monitoring signal power received from the strongest co-channel open-access cell and a handover rate in the node; and
if the signal power received from the strongest co-channel open-access cell and/or the handover rate in the node does not fulfill the set conditions,
adjusting transmission power of the node for improving radio coverage.

11. The method of claim 10, wherein the adjustment of the transmission power of the node acting as a handover source node or target node comprises at least one of: usage of a maximum power, adjustment of power control parameters controlling slope of power control curve and/or pathloss correction offset, and usage of a maximum power on a dedicated frequency only, in the case the signal power received from the strongest co-channel open-access cell and the handover rate in the node do not fulfil the set conditions.

12. The method of claim 10, wherein the adjustment of the transmission power of the node acting as a handover source node or target node comprises usage of a maximum transmission power on a dedicated frequency in the case the handover rate in the node does not fulfil the set condition.

13. The method of claim 10, wherein the adjustment of the transmission power of the node acting as a handover source node comprises at least one of: usage of a maximum power, adjustment of power control parameters controlling slope of power control curve and/or pathloss correction offset, and usage of a maximum power on a dedicated frequency only, if the signal power received from the strongest co-channel open-access cell does not fulfil the set condition.

14. The method of claim 10, wherein the signal power received from a strongest co-channel open-access cell is a received signal reference power.

15. The method of claim 10, wherein in each case the selection of actions to be taken is based on the instructions of operation and maintenance functions.

16. An apparatus comprising:
means for receiving conditions set for signal power received from a strongest co-channel open-access cell and for a handover rate in a node;
means for monitoring signal power received from the strongest co-channel open-access cell and a handover rate in the node; and
if the signal power received from the strongest co-channel open-access cell and/or the handover rate in the node does not fulfill the set conditions,
means for adjusting transmission power of the node for improving radio coverage.

17. A computer program product embodied on a computer readable medium, the computer program being configured to control a processor to perform:
receiving conditions set for signal power received from a strongest co-channel open-access cell and for a handover rate in a node;
monitoring signal power received from the strongest co-channel open-access cell and a handover rate in the node; and
if the signal power received from the strongest co-channel open-access cell and/or the handover rate in the node does not fulfill the set conditions,
adjusting transmission power of the node for improving radio coverage.

18. The computer program product of claim 17, wherein the adjustment of the transmission power of the node acting as a handover source node or target node comprises at least one of: usage of a maximum power, adjustment of power control parameters controlling slope of power control curve and/or pathloss correction offset, and usage of a maximum power on a dedicated frequency only, in the case the signal power received from the strongest co-channel open-access cell and the handover rate in the node do not fulfil the set conditions.

19. The computer program product of claim 17, wherein the adjustment of the transmission power of the node acting as a handover source node or target node comprises usage of a maximum transmission power on a dedicated frequency in the case the handover rate in the node does not fulfil the set condition.

20. The computer program product of claim 17, wherein the adjustment of the transmission power of the node acting as a handover source node comprises at least one of: usage of a maximum power, adjustment of power control parameters controlling slope of power control curve and/or pathloss correction offset, and usage of a maximum power on a dedicated frequency only, if the signal power received from the strongest co-channel open-access cell does not fulfil the set condition.

21. The computer program product of claim 17, wherein the signal power received from a strongest co-channel open-access cell is a received signal reference power.

22. The computer program product of claim 17, wherein in each case the selection of actions to be taken is based on the instructions of operation and maintenance functions.

23. A computer-readable medium encoded with instructions that, when executed by a computer, perform:
receiving conditions set for signal power received from a strongest co-channel open-access cell and for a handover rate in a node;
monitoring signal power received from the strongest co-channel open-access cell and a handover rate in the node; and
if the signal power received from the strongest co-channel open-access cell and/or the handover rate in the node does not fulfill the set conditions,
adjusting transmission power of the node for improving radio coverage.

24. The computer-readable medium of claim 23, wherein the adjustment of the transmission power of the node acting as a handover source node or target node comprises at least one of: usage of a maximum power, adjustment of power control parameters controlling slope of power control curve and/or pathloss correction offset, and usage of a maximum power on a dedicated frequency only, in the case the signal power received from the strongest co-channel open-access cell and the handover rate in the node do not fulfil the set conditions.

25. The computer-readable medium of claim 23, wherein the adjustment of the transmission power of the node acting as a handover source node or target node comprises usage of a maximum transmission power on a dedicated frequency in the case the handover rate in the node does not fulfil the set condition.
